(19) United States
(12) Patent Application Publication
(10) Pub. No.: US 2025/0331497 A1
(43) Pub. Date: Oct. 30, 2025

(54) PET HAIR CARE KIT

(71) Applicant: Guangdong Yinuo Pet Intelligent Technology Co., Ltd., Dongguan (CN)

(72) Inventors: Bo ZHU, Dongguan (CN); Song LI, Dongguan (CN)

(73) Assignee: Guangdong Yinuo Pet Intelligent Technology Co., Ltd., Dongguan (CN)

(21) Appl. No.: 18/658,294

(22) Filed: May 8, 2024

(30) Foreign Application Priority Data
Apr. 29, 2024 (CN) 2024105342475

(51) Int. Cl. A01K 13/00; A46B 5/00; A46B 15/00

(52) U.S. Cl. CPC A01K 13/002; A46B 5/0095; A46B 15/0044; A46B 15/0053; A46B 2200/1093

(57) ABSTRACT

The present invention discloses a pet hair care kit, relating to the technical field of pet care. The pet hair care kit includes a main machine, a first care accessory, and a second care accessory. The first care accessory and the second care accessory can be assembled on an adsorption end of the main machine, and can also be detached from the main machine. The first care accessory cleans shed pet hair in a hair sticking manner, and the second care accessory grooms pet hair and cleans shed hair in a grooming manner. According to the pet hair care kit, two sets of different care accessories may be respectively assembled on the main machine, one of the care accessories can implement a hair sticking function, and the other care accessory can implement a grooming function. Both of the accessories can clean shed hair from a body of a pet.

### CROSS-REFERENCE TO RELATED APPLICATIONS

The application claims priority to Chinese patent application No. 2024105342475, filed on Apr. 29, 2024, the entire contents of which are incorporated herein by reference.

### TECHNICAL FIELD

The present invention relates to the technical field of pet care, and specifically, to a pet hair care kit.

### BACKGROUND

In modern home life, pet feeding has been relatively common. During daily care of a pet, it is needed to groom hair that falls off from a body of the pet, that is, shed hair. There are mainly two existing kits for pet hair care: one is a hair sticking kit as described in the published patent No. CN214508744U, and the other is a grooming kit as described in the published patent No. CN216452619U.

According to the above two pet hair care kits, different tools need to be correspondingly used when adopting different manners. In addition, both of the above two pet hair care kits can only clean the shed hair from the body of the pet, but cannot collect cleaned hair, which is functionally insufficient. Therefore, a care kit that has two heads and can collect the cleaned hair is provided.

### SUMMARY

For the defects in the prior art, the present invention provides a pet hair care kit, to resolve the above problem proposed in the background.

In order to achieve the purpose mentioned above, the present invention adopts the following technical solution:
according to a first aspect, the present invention provides a pet hair care kit, including a main machine and a first care accessory, where the main machine can collect, in an adsorption manner, pet hair removed by the first care accessory, the first care accessory is fixed on an air suction end of the main machine, the first care accessory can be detached from the main machine, and the first care accessory can clean shed pet hair in a rolling-sticking manner.

Further, the main machine includes a handgrip, where an air outlet member is fixedly connected to a bottom end of the handgrip, and the handgrip is internally provided with a first cavity and a second cavity. A first base body is fixedly installed on the bottom of the first cavity, a power supply is fixedly connected in the first base body, a circuit board is fixedly connected in the second cavity, the circuit board is respectively and integrally provided with an indicator light, a contact switch, and a charging interface, a panel is fixed to a side portion of the handgrip in a clamped manner, an upper portion of the panel is respectively provided with a lamp housing and a switch keycap, and positions of the lamp housing and the switch keycap respectively correspond to the indicator light and the contact switch. A second base body is fixedly connected to a top end of the handgrip, a diversion window is installed in a hole reserved on the second base body, a support body is fixedly connected to a bottom end of the second base body, a suction fan is fixedly installed in the support body, a dust collection box is fixed in the second base body in a clamped manner, and a first air guiding opening is reserved on a side portion of the second base body. An inner side of an end portion of the second base body is rotatably connected to a handle and is fixedly provided with a travel switch and an electrical connection base, a pressing end of the handle extends out through a hole reserved on the handgrip, a first conductive post is fixedly connected in the electrical connection base, and a second air guiding opening communicating with the first air guiding opening is reserved on the bottom of the electrical connection base. A clasping female header is fixedly connected to the end portion of the second base body, a third air guiding opening communicating with the second air guiding opening is reserved on a middle portion of the clasping female header, first through holes are reserved on two sides of the clasping female header, a limiting post is slidably disposed in the first through hole, a push plate is fixedly connected to an end, facing away from the clasping female header, of the limiting post, a spring is sleeved outside the limiting post, the spring abuts between the clasping female header and the push plate, and the push plate abuts against the top end of the handle. A dust inlet communicating with the first air guiding opening is reserved on a side portion of the dust collection box, a bottom plate that can be turned over is connected to a bottom end of the dust collection box in a clamped manner, a filter cartridge is fixedly installed in the bottom plate, and the filter cartridge communicates with the diversion window.

Further, the first care accessory includes a first clasping male header, where an inner frame is fixedly connected in the first clasping male header, a hair sticking roller is rotatably connected in the inner frame, brush plates are rotatably connected to both of an upper portion and a lower portion of the hair sticking roller in the inner frame, a torsional spring is disposed between a main shaft of the brush plate and the inner frame, a first face cover is fixedly connected to an end face of the first clasping male header, and edges of the hair sticking roller and the brush plate both protrude from the first face cover. The hair sticking roller includes a roller shaft that is rotatably connected in the inner frame, rolling wheels are connected to two ends of the roller shaft, grooming stickers and silicone strips are respectively connected to a surface of the roller shaft, and the grooming stickers and the silicone strips are alternately distributed on the surface of the roller shaft.

According to a second aspect, the present invention further provides a pet hair care kit, including a main machine and a second care accessory, where on one hand, the main machine can remove pet hair groomed and removed by the second care accessory from the second care accessory, and on the other hand, the main machine can collect removed pet hair in an adsorption manner; and the second care accessory is fixed on an air suction end of the main machine, the second care accessory can be detached from the main machine, and the second care accessory can groom the pet hair and clean shed hair in a grooming manner.

Further, the main machine includes a handgrip, where an air outlet member is fixedly connected to a bottom end of the handgrip, and the handgrip is internally provided with a first cavity and a second cavity. A first base body is fixedly installed on the bottom of the first cavity, a power supply is fixedly connected in the first base body, a circuit board is fixedly connected in the second cavity, the circuit board is respectively and integrally provided with an indicator light, a contact switch, and a charging interface, a panel is fixed to a side portion of the handgrip in a clamped manner, an upper portion of the panel is respectively provided with a lamp housing and a switch keycap, and positions of the lamp housing and the switch keycap respectively correspond to the indicator light and the contact switch. A second base body is fixedly connected to a top end of the handgrip, a diversion window is installed in a hole reserved on the second base body, a support body is fixedly connected to a bottom end of the second base body, a suction fan is fixedly installed in the support body, a dust collection box is fixed in the second base body in a clamped manner, and a first air guiding opening is reserved on a side portion of the second base body. An inner side of an end portion of the second base body is rotatably connected to a handle and is fixedly provided with a travel switch and an electrical connection base, a pressing end of the handle extends out through a hole reserved on the handgrip, a first conductive post is fixedly connected in the electrical connection base, and a second air guiding opening communicating with the first air guiding opening is reserved on the bottom of the electrical connection base. A clasping female header is fixedly connected to the end portion of the second base body, a third air guiding opening communicating with the second air guiding opening is reserved on a middle portion of the clasping female header, first through holes are reserved on two sides of the clasping female header, a limiting post is slidably disposed in the first through hole, a push plate is fixedly connected to an end, facing away from the clasping female header, of the limiting post, a spring is sleeved outside the limiting post, the spring abuts between the clasping female header and the push plate, and the push plate abuts against the top end of the handle. A dust inlet communicating with the first air guiding opening is reserved on a side portion of the dust collection box, a bottom plate that can be turned over is connected to a bottom end of the dust collection box in a clamped manner, a filter cartridge is fixedly installed in the bottom plate, and the filter cartridge communicates with the diversion window.

Further, the second care accessory includes a second clasping male header and a second face cover movably connected to the second clasping male header, a lamp plate, a light transmissive plate, and a comb head base are respectively and fixedly disposed in the second clasping male header in sequence, a post hole is reserved on a back face of the second clasping male header, a second through hole is internally reserved on the second clasping male header, a second conductive post is integrally connected to a back face of the lamp plate, a plurality of lamp covers are integrally connected to a front face of the light transmissive plate, a plurality of comb teeth are fixedly connected in the comb head base, a plurality of comb tooth moving holes are reserved on a front face of the second face cover, the comb teeth can move in the comb tooth moving holes, a push rod is fixedly connected to a back face of the second face cover, the push rod is inserted into the second through hole, and middle portions of the second clasping male header, the lamp plate, the light transmissive plate, the comb head base, and the second face cover are all provided with fourth air guiding openings communicating with each other.

Compared with the prior art, a pet hair care kit provided by the present invention has the following benefits:
1. According to the pet hair care kit, two sets of different care accessories may be respectively assembled on the main machine, one of the care accessories can implement a hair sticking function, and the other care accessory can implement a grooming function. Both of the accessories can clean shed hair from a body of a pet. Users can use a corresponding accessory according to their own manners without purchasing a plurality of care kits.
2. According to the pet hair care kit, the disposed main machine has a function of adsorbing and collecting hair. Regardless of which accessory cleans shed pet hair, the main machine can collect the hair and separate the hair from air, thereby protecting living environments of the users and facilitating use by the users.
3. According to the pet hair care kit, during use of a grooming accessory, the suction fan in the main machine is not always in an operating state. After the hair on the accessory is collected to be saturated, in a pressing manner, the user can not only push down collected hair from the accessory, but also start the suction fan simultaneously, to implement a function of sucking hair for collection. In this way, on one hand, use duration of the suction fan is reduced, and a service life is prolonged, and on the other hand, electric power can be saved.

### BRIEF DESCRIPTION OF DRAWINGS

FIG. 1 is a schematic structural diagram in which a main machine is used with a first care accessory according to the present invention;

FIG. 2 is a schematic structural diagram in which a main machine is used with a second care accessory according to the present invention;

FIG. 3 is a schematic exploded view of a main machine according to the present invention;

FIG. 4 is a schematic structural diagram of a circuit board and a panel according to the present invention;

FIG. 5 is a schematic structural diagram of a dust collection box according to the present invention;

FIG. 6 is a schematic exploded view of a first care accessory according to the present invention;

FIG. 7 is a schematic structural diagram of a hair sticking roller according to the present invention;

FIG. 8 is a semisectional view of FIG. 1 and a schematic diagram of an airflow path;

FIG. 9 is a schematic exploded view of a second care accessory according to the present invention;

FIG. 10 is a schematic structural diagram of a second face cover according to the present invention;

FIG. 11 is a schematic structural diagram of a lamp plate according to the present invention;

FIG. 12 is a schematic diagram of a process in which a second face cover is pushed out by pressing a handle according to the present invention;

FIG. 13 is a semisectional view of FIG. 2 and a schematic diagram of an airflow path; and

FIG. 14 is a schematic diagram of an air outlet according to the present invention.

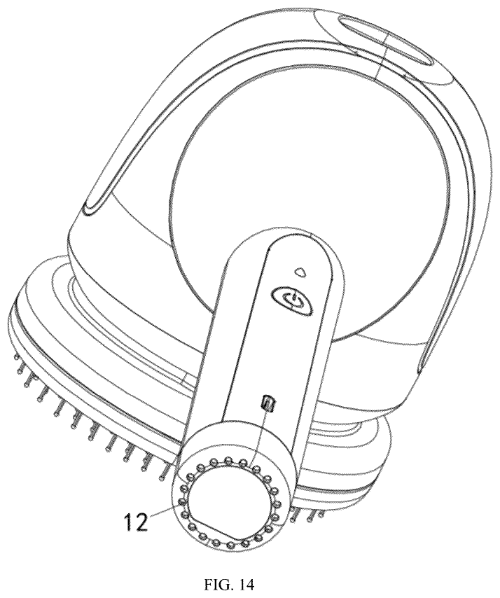

In the drawings: 1. main machine; 11. handgrip; 12. air outlet member; 13. first base body; 14. power supply; 15. circuit board; 16. indicator light; 17. contact switch; 18. charging interface; 19. panel; 110. lamp housing; 111. switch keycap; 112. second base body; 113. diversion window; 114. support body; 115. suction fan; 116. handle; 117. travel switch; 118. dust collection box; 1181. dust inlet; 1182. bottom plate; 1183. filter cartridge; 119. first air guiding opening; 120. electrical connection base; 121. second air guiding opening; 122. first conductive post; 123. push plate; 124. limiting post; 125. clasping female header; 126. spring; 127. third air guiding opening; 128. first through hole; 2. first care accessory; 21. first clasping male header; 22. inner frame; 23. hair sticking roller; 231. roller shaft; 232. rolling wheel; 233. grooming sticker; 234. silicone strip; 24. brush plate; 25. torsional spring; 26. first face cover; 27. sealing ring; 3. second care accessory; 31. second clasping male header; 311. post hole; 312. second through hole; 32. lamp plate; 321. second conductive post; 33. light transmissive plate; 331. lamp cover; 34. comb head base; 35. comb tooth; 36. second face cover; 361. fourth air guiding opening; 362. comb tooth moving hole; 363. push rod.

### DETAILED DESCRIPTION OF THE EMBODIMENTS

An explicit and complete description of the technical solution in the embodiments of the present invention is given below in conjunction with the accompanying drawings in the embodiments of the present invention. Apparently, the described embodiments are merely a part of the embodiments of the present invention, not all of the embodiments. Based on the embodiments in the present invention, all other embodiments obtained by those of ordinary skill in the art without making creative labor shall fall within the protection scope of the present invention.

### Embodiment 1

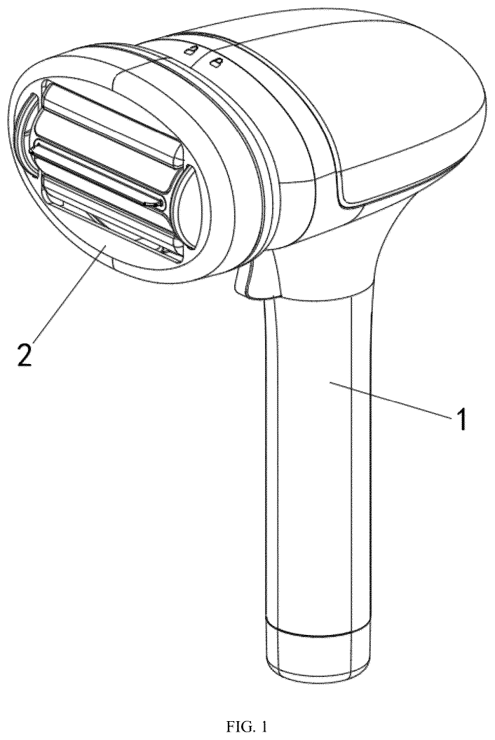

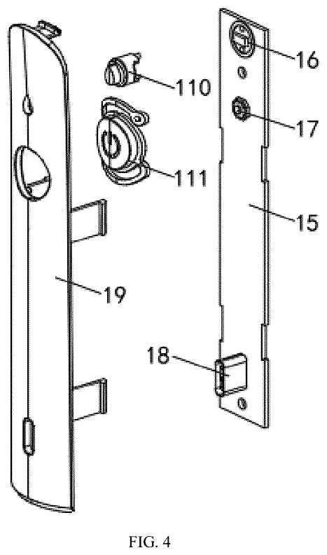

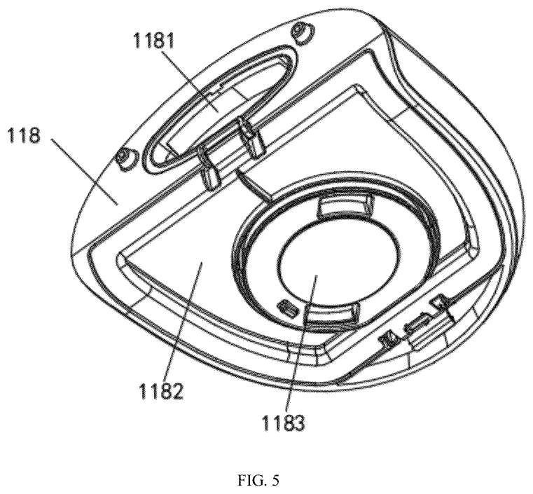

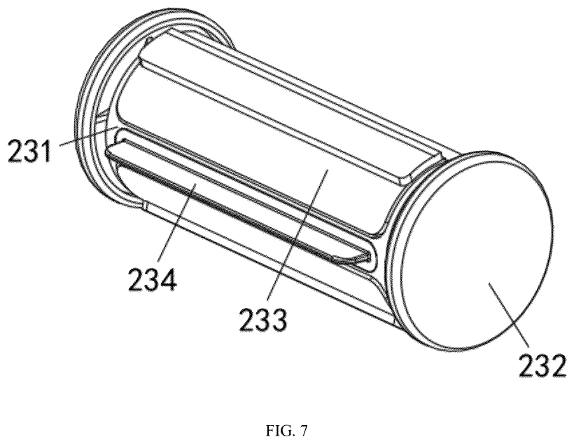

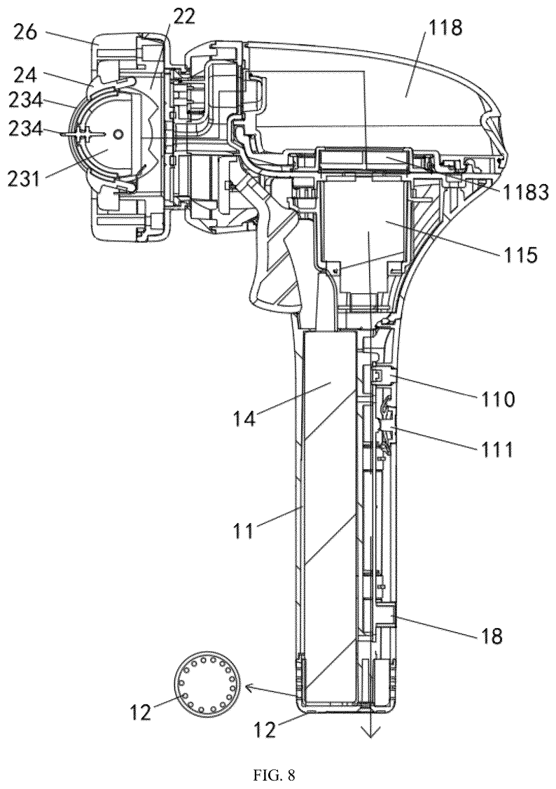

Referring to FIGS. 1, 3, 4, 5, 6, 7, and 8, the present invention provides a technical solution that: a pet hair care kit includes a main machine 1 and a first care accessory 2, where the main machine 1 can collect, in an adsorption manner, pet hair removed by the first care accessory 2, the first care accessory 2 is fixed on an air suction end of the main machine 1, the first care accessory 2 can be detached from the main machine 1, and the first care accessory 2 can clean shed pet hair in a rolling-sticking manner. On this basis, the first care accessory 2 can be directly attached to a surface of pet hair to move. During movement, the first care accessory 2 can stick shed hair from a body of a pet and collect stuck hair by means of a powerful adsorption capability of the main machine 1.

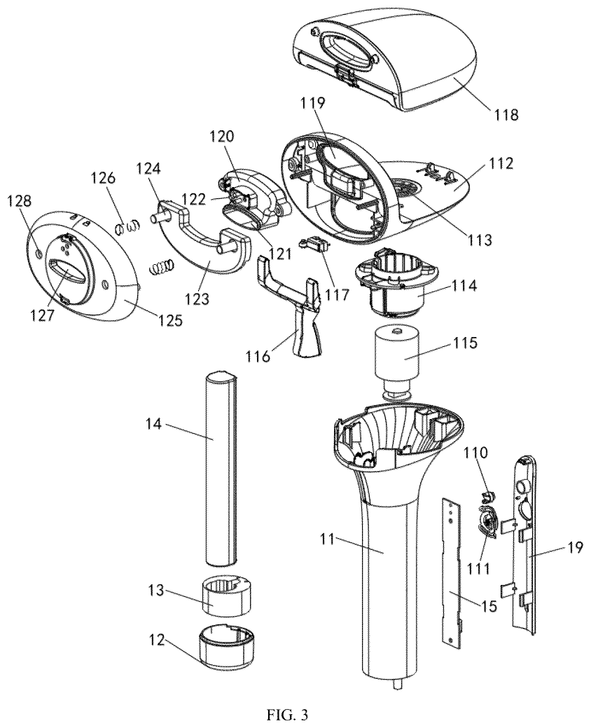

Referring to FIGS. 3, 4, 5, and 8, the main machine 1 includes a handgrip 11, where an air outlet member 12 is fixedly connected to a bottom end of the handgrip 11, a surface of the air outlet member 12 is provided with a plurality of air outlet holes, air sucked by the main machine 1 is discharged from the air outlet member 12, and the handgrip 11 is internally divided into a first cavity and a second cavity. A first base body 13 is fixedly installed on the bottom of the first cavity, and a power supply 14 is fixedly connected in the first base body 13, so that the entire care kit operates in a charging mode without external wiring. A circuit board 15 is fixedly connected in the second cavity, the circuit board 15 is respectively and integrally provided with an indicator light 16, a contact switch 17, and a charging interface 18, a panel 19 is fixed to a side portion of the handgrip 11 in a clamped manner, an upper portion of the panel 19 is respectively provided with a lamp housing 110 and a switch keycap 111, and positions of the lamp housing 110 and the switch keycap 111 respectively correspond to the indicator light 16 and the contact switch 17. The contact switch 17 is triggered by pressing the switch keycap 111, so that the entire care kit starts operating. During operation, the indicator light 16 is normally on. A second base body 112 is fixedly connected to a top end of the handgrip 11, a diversion window 113 is installed in a hole reserved on the second base body 112, a support body 114 is fixedly connected to a bottom end of the second base body 112, a suction fan 115 is fixedly installed in the support body 114, a dust collection box 118 is fixed in the second base body 112 in a clamped manner, and a first air guiding opening 119 is reserved on a side portion of the second base body 112. A clasping female header 125 is fixedly connected to an end portion of the second base body 112, and a third air guiding opening 127 is reserved on a middle portion of the clasping female header 125. A dust inlet 1181 communicating with the first air guiding opening 119 is reserved on a side portion of the dust collection box 118, a bottom plate 1182 that can be turned over is connected to a bottom end of the dust collection box 118 in a clamped manner, a filter cartridge 1183 is fixedly installed in the bottom plate 1182, and the filter cartridge 1183 communicates with the diversion window 113. After the pet hair is cleaned, the suction fan 115 operates to generate powerful suction force, so that the hair and air enter the dust collection box 118. After filtering is performed by the filter cartridge 1183, the pet hair is kept in the dust collection box 118, and the air enters the handgrip 11 through the diversion window 113 and is discharged out of the entire care kit through the air outlet member 12.

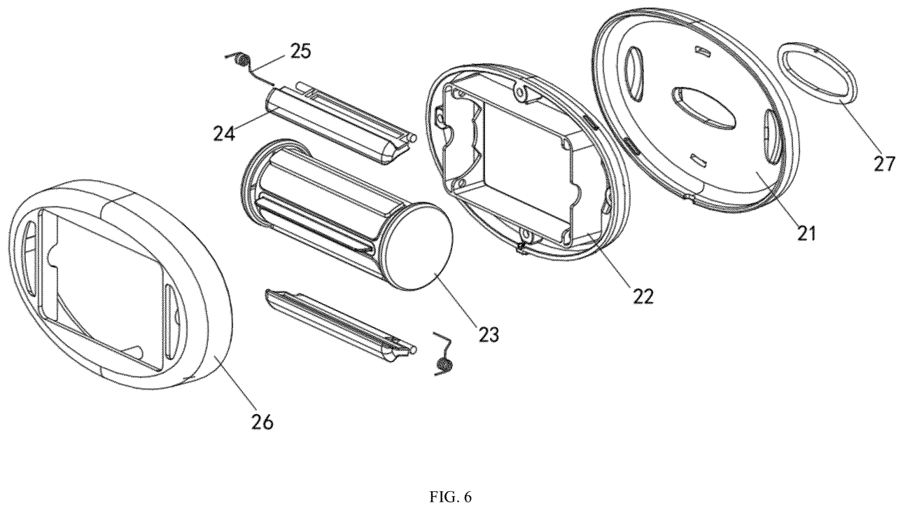

Referring to FIGS. 6, 7, and 8, the first care accessory 2 includes a first clasping male header 21, and the first clasping male header 21 is fixed to the clasping female header 125 in a clamped manner, so that the entire first care accessory 2 is assembled on the main machine 1. An inner frame 22 is fixedly connected in the first clasping male header 21, a hair sticking roller 23 is rotatably connected in the inner frame 22, and brush plates 24 are rotatably connected to both of an upper portion and a lower portion of the hair sticking roller 23 in the inner frame 22, where a function of the brush plate 24 is to brush away pet hair attached to the hair sticking roller 23 when the hair sticking roller 23 rotates and carries the pet hair. A torsional spring 25 is disposed between a main shaft of the brush plate 24 and the inner frame 22, where a function of the torsional spring 25 is to enable the brush plate 24 to be attached to a surface of the hair sticking roller 23. A first face cover 26 is fixedly connected to an end face of the first clasping male header 21, and edges of the hair sticking roller 23 and the brush plate 24 both protrude from the first face cover 26, where only protruding hair sticking roller 23 can be in better contact with the pet hair. A sealing ring 27 is disposed at a joint between the first clasping male header 21 and the clasping female header 125, the hair sticking roller 23 includes a roller shaft 231 that is rotatably connected in the inner frame 22, and rolling wheels 232 are connected to two ends of the roller shaft 231, where the rolling wheels 232 roll on the surface of the pet hair. Grooming stickers 233 and silicone strips 234 are respectively connected to a surface of the roller shaft 231, and the grooming stickers 233 and the silicone strips 234 are alternately distributed on the surface of the roller shaft 231, where the grooming stickers 233 can stick shed pet hair, and the silicone strips 234 can jack up the brush plate 24 during rotation to facilitate air circulation.

According to the pet hair care kit in the embodiment, during operation, the first care accessory 2 is assembled on the main machine 1, and then the suction fan 115 is started to operate to generate suction force. In this case, a user may hold the main machine 1, and the first care accessory 2 moves on the surface of the pet hair. During movement, the grooming sticker 233 sticks shed pet hair, and the grooming sticker 233 with stuck pet hair rotates with the roller shaft 231. When the grooming sticker 233 passes through the brush plate 24, the pet hair stuck on a surface of the grooming sticker 233 is separated from the surface of the grooming sticker 233. In addition, when the roller shaft 231 continues to rotate, the silicone strip 234 jacks up the brush plate 24, and external air flows into the first care accessory 2 under powerful suction force of the suction fan 115. During flow, the air carries separated pet hair, passes through the third air guiding opening 127, the first air guiding opening 119, and the dust inlet 1181 in sequence, and finally enters the dust collection box 118. After filtering is performed on the hair and the air by the filter cartridge 1183, the hair is kept in the dust collection box 118, and the air enters the handgrip 11 through the filter cartridge 1183 and the diversion window 113 and is discharged out from the air outlet member 12. After the dust collection box 118 collects enough hair, the user may detach the dust collection box 118 and open the bottom plate 1182 to pour out the hair.

In conclusion, for the pet hair care kit in the embodiment, a main use method includes: removing shed hair from a body of a pet in a rolling-sticking manner, and collecting removed shed hair through powerful suction force.

### Embodiment 2

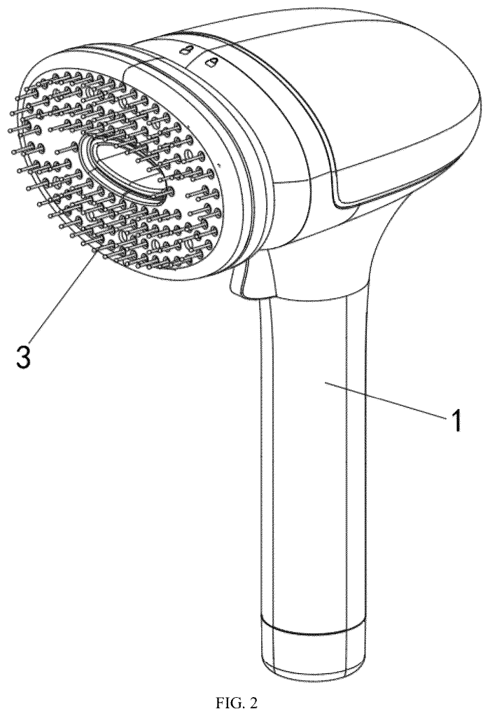

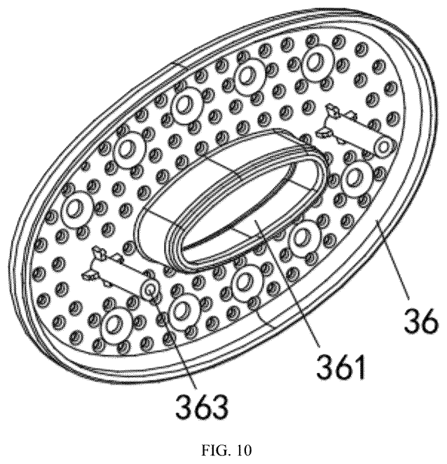

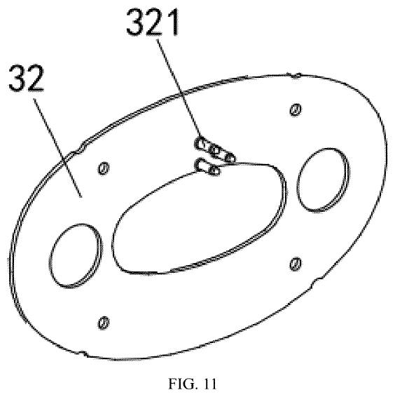

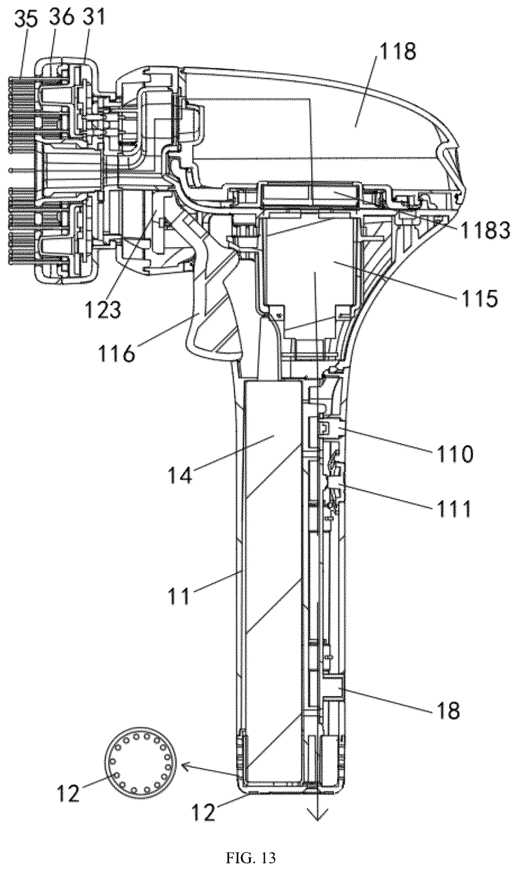

Referring to FIGS. 2, 3, 4, 5, 9, 10, 11, 12, and 13, the present invention provides a technical solution that: a pet hair care kit includes a main machine 1 and a second care accessory 3, where on one hand, the main machine 1 can remove pet hair groomed and removed by the second care accessory 3 from the second care accessory 3, and on the other hand, the main machine can collect removed pet hair in an adsorption manner; and the second care accessory 3 is fixed on an air suction end of the main machine 1, the second care accessory 3 can be detached from the main machine 1, and the second care accessory 3 can groom the pet hair and clean shed hair in a grooming manner.

Referring to FIGS. 3, 4, 5, and 13, the main machine 1 includes a handgrip 11, where an air outlet member 12 is fixedly connected to a bottom end of the handgrip 11, a surface of the air outlet member 12 is provided with a plurality of air outlet holes, air sucked by the main machine 1 is discharged from the air outlet member 12, and the handgrip 11 is internally divided into a first cavity and a second cavity. A first base body 13 is fixedly installed on the bottom of the first cavity, and a power supply 14 is fixedly connected in the first base body 13, so that the entire care kit operates in a charging mode without external wiring. A circuit board 15 is fixedly connected in the second cavity, the circuit board 15 is respectively and integrally provided with an indicator light 16, a contact switch 17, and a charging interface 18, a panel 19 is fixed to a side portion of the handgrip 11 in a clamped manner, an upper portion of the panel 19 is respectively provided with a lamp housing 110 and a switch keycap 111, and positions of the lamp housing 110 and the switch keycap 111 respectively correspond to the indicator light 16 and the contact switch 17. The contact switch 17 is triggered by pressing the switch keycap 111, so that the entire care kit starts operating. During operation, the indicator light 16 is normally on, a second base body 112 is fixedly connected to a top end of the handgrip 11, a diversion window 113 is installed in a hole reserved on the second base body 112, a support body 114 is fixedly connected to a bottom end of the second base body 112, a suction fan 115 is fixedly installed in the support body 114, a dust collection box 118 is fixed in the second base body 112 in a clamped manner, and a first air guiding opening 119 is reserved on a side portion of the second base body 112. A clasping female header 125 is fixedly connected to an end portion of the second base body 112, and a third air guiding opening 127 is reserved on a middle portion of the clasping female header 125. In addition, first through holes 128 are reserved on two sides of the clasping female header 125, a limiting post 124 is slidably disposed in the first through hole 128, a push plate 123 is fixedly connected to an end, facing away from the clasping female header 125, of the limiting post 124, a spring 126 is sleeved outside the limiting post 124, the spring 126 abuts between the clasping female header 125 and the push plate 123, and the push plate 123 abuts against the top end of the handle 116. The handle 116 is rotatably connected to the second base body 112, and a pressing end of the handle 116 extends out through a hole reserved on the handgrip 11. When the handle 116 is pressed, the handle 116 is enabled to be deflected, and an upper end of the handle 116 squeezes the push plate 123 to move toward a direction of the clasping female header 125, so that the limiting post 124 that is originally hidden in the first through hole 128 protrudes out of the first through hole 128 after being moved. A dust inlet 1181 communicating with the first air guiding opening 119 is reserved on a side portion of the dust collection box 118, a bottom plate 1182 that can be turned over is connected to a bottom end of the dust collection box 118 in a clamped manner, a filter cartridge 1183 is fixedly installed in the bottom plate 1182, and the filter cartridge 1183 communicates with the diversion window 113. After the pet hair is cleaned, the suction fan 115 operates to generate powerful suction force, so that the hair and air enter the dust collection box 118. After filtering is performed on the hair and the air by the filter cartridge 1183, the pet hair is kept in the dust collection box 118, and the air enters the handgrip 11 through the diversion window 113 and is discharged out of the entire care kit through the air outlet member 12.

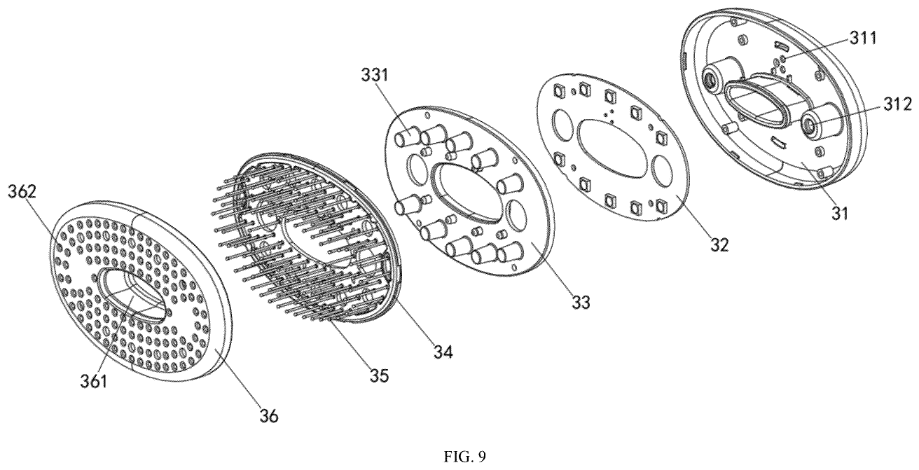

Referring to FIGS. 9, 10, 11, 12, and 13, the second care accessory 3 includes a second clasping male header 31 and a second face cover 36 movably connected to the second clasping male header 31. A lamp plate 32, a light transmissive plate 33, and a comb head base 34 are respectively and fixedly disposed in the second clasping male header 31 in sequence, where a plurality of lamp beads are integrated on the lamp plate 32, the lamp bead can emit specific lamplight, and the lamplight is applied to pet hair and skin for hair care. A post hole 311 is reserved on a back face of the second clasping male header 31, a second through hole 312 is internally reserved on the second clasping male header 31, a second conductive post 321 is integrally connected to a back face of the lamp plate 32, and the second conductive post 321 is in contact with a first conductive post 122, so that electric conduction can be implemented, thereby supplying power to the lamp plate 32. A plurality of lamp covers 331 are integrally connected to a front face of the light transmissive plate 33, each lamp bead is located in the lamp cover 331 correspondingly, a plurality of comb teeth 35 are fixedly connected in the comb head base 34, a plurality of comb tooth moving holes 362 are reserved on a front face of the second face cover 36, the comb teeth 35 can move in the comb tooth moving holes 362, a push rod 363 is fixedly connected to a back face of the second face cover 36, the push rod 363 is inserted into the second through hole 312, and similarly, the spring 126 abuts between the push rod and the second through hole. Middle portions of the second clasping male header 31, the lamp plate 32, the light transmissive plate 33, the comb head base 34, and the second face cover 36 are all provided with fourth air guiding openings (361) communicating with each other. In the above description, pressing the handle 116 enables the limiting post 124 to protrude from the interior of the first through hole 128 finally, and after protruding, the limiting post 124 abuts against the push rod 363, so that the second face cover 36 is pushed to move relative to the comb teeth 35. In this case, hair interspersed in the comb teeth 35 is removed.

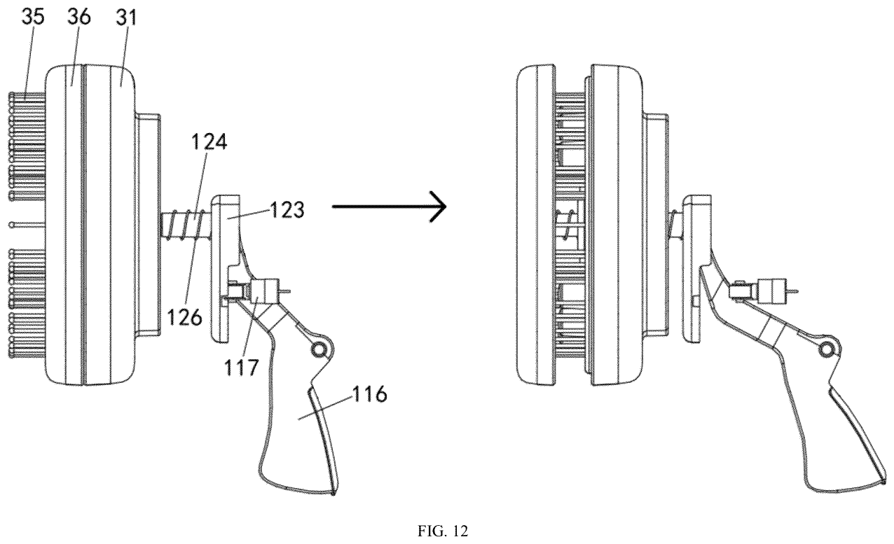

According to the pet hair care kit in the embodiment, during operation, the second care accessory 3 is assembled on the main machine 1. After assembly, a user may similarly hold the main machine 1, to enable the second care accessory 3 to move on a surface of pet hair. During movement, the pet hair is collected and interspersed among the comb teeth 35. When the pet hair collected among the comb teeth 35 reaches a certain amount, the handle 116 can be pressed to be deflected, the upper end of the handle 116 squeezes the push plate 123 to move toward the direction of the clasping female header 125, and the limiting post 124 moves synchronously, so that the limiting post 124 that is originally hidden in the first through hole 128 protrudes out of the first through hole 128. At the same time, a travel switch 117 abuts between the push plate 123 and the second base body 112, and therefore, when the push plate 123 moves, the travel switch 117 is turned on, and the suction fan 115 starts operating at this time. In other words, the suction fan 115 does not operate when the user grooms pet hair, but only operates when the hair among the comb teeth 35 needs to be removed, thus saving electric power. During a process in which the limiting post 124 protrudes out of the first through holes 128, the push rod 363 is pushed to move synchronously, so that the second face cover 36 is pushed to move relative to the comb teeth 35. In this case, the hair originally collected among the comb teeth 35 can be removed (the process is as shown in FIG. 12), and the hair does not fall off while being removed. Instead, under the powerful suction force of the suction fan 115, the hair, together with the air, passes through the fourth air guiding opening 361, the third air guiding opening 127, the second air guiding opening 121, the first air guiding opening 119, and the dust inlet 1181 in sequence, and finally enters the dust collection box 118. After filtering is performed on the hair and the air by the filter cartridge 1183, the hair is kept in the dust collection box 118, and the air enters the handgrip 11 through the filter cartridge 1183 and the diversion window 113 and is discharged from the air outlet member 12. After all of the removed hair is sucked, the user releases the handle 116, and the second face cover 36, the push rod 363, the limiting post 124, the push plate 123, and the handle 116 are all reset automatically under action of the spring 126. In this case, the travel switch 117 is turned off after being squeezed by the push plate 123, and the suction fan 115 stops operating. After the dust collection box 118 collects enough hair, the user may detach the dust collection box 118 and open the bottom plate 1182, to pour out the hair.

In conclusion, for the pet hair care kit in the embodiment, a main use method includes: removing shed hair from a body of a pet in grooming manner, and collecting removed shed hair through powerful suction force.

What is claimed is:

1. A pet hair care kit, comprising: a main machine (1) and a first care accessory (2), wherein
the main machine (1) can collect, in an adsorption manner, pet hair removed by the first care accessory (2); and
the first care accessory (2) is fixed on an air suction end of the main machine (1), the first care accessory (2) can be detached from the main machine (1), and the first care accessory (2) can clean shed pet hair in a rolling-sticking manner.

2. A pet hair care kit, comprising: a main machine (1) and a second care accessory (3), wherein
on one hand, the main machine (1) can remove pet hair groomed and removed by the second care accessory (3) from the second care accessory (3), and on the other hand, the main machine can collect removed pet hair in an adsorption manner; and
the second care accessory (3) is fixed on an air suction end of the main machine (1), the second care accessory (3) can be detached from the main machine (1), and the second care accessory (3) can groom the pet hair and clean shed hair in a grooming manner.

3. The pet hair care kit according to claim 1, wherein the main machine (1) comprises a handgrip (11), an air outlet member (12) is fixedly connected to a bottom end of the handgrip (11), and the handgrip (11) is internally provided with a first cavity and a second cavity, wherein a first base body (13) is fixedly installed on a bottom of the first cavity, a power supply (14) is fixedly connected in the first base body (13), a circuit board (15) is fixedly connected in the second cavity, the circuit board (15) is respectively and integrally provided with an indicator light (16), a contact switch (17), and a charging interface (18), a panel (19) is fixed to a side portion of the handgrip (11) in a clamped manner, an upper portion of the panel (19) is respectively provided with a lamp housing (110) and a switch keycap (111), and positions of the lamp housing (110) and the switch keycap (111) respectively correspond to the indicator light (16) and the contact switch (17).

4. The pet hair care kit according to claim 3, wherein a second base body (112) is fixedly connected to a top end of the handgrip (11), a diversion window (113) is installed in a hole reserved on the second base body (112), a support body (114) is fixedly connected to a bottom end of the second base body (112), a suction fan (115) is fixedly installed in the support body (114), a dust collection box (118) is fixed in the second base body (112) in a clamped manner, and a first air guiding opening (119) is reserved on a side portion of the second base body (112).

5. The pet hair care kit according to claim 4, wherein an inner side of an end portion of the second base body (112) is rotatably connected to a handle (116) and is fixedly provided with a travel switch (117) and an electrical connection base (120), a pressing end of the handle (116) extends out through a hole reserved on the handgrip (11), a first conductive post (122) is fixedly connected in the electrical connection base (120), and a second air guiding opening (121) communicating with the first air guiding opening (119) is reserved on a bottom of the electrical connection base (120).

6. The pet hair care kit according to claim 5, wherein a clasping female header (125) is fixedly connected to the end portion of the second base body (112), a third air guiding opening (127) communicating with the second air guiding opening (121) is reserved on a middle portion of the clasping female header (125), first through holes (128) are reserved on two sides of the clasping female header (125), a limiting post (124) is slidably disposed in the first through hole (128), a push plate (123) is fixedly connected to an end, facing away from the clasping female header (125), of the limiting post (124), a spring (126) is sleeved outside the limiting post (124), the spring (126) abuts between the clasping female header (125) and the push plate (123), and the push plate (123) abuts against a top end of the handle (116).

7. The pet hair care kit according to claim 4, wherein a dust inlet (1181) communicating with the first air guiding opening (119) is reserved on a side portion of the dust collection box (118), a bottom plate (1182) that can be turned over is connected to a bottom end of the dust collection box (118) in a clamped manner, a filter cartridge (1183) is fixedly installed in the bottom plate (1182), and the filter cartridge (1183) communicates with the diversion window (113).

8. The pet hair care kit according to claim 1, wherein the first care accessory (2) comprises a first clasping male header (21), an inner frame (22) is fixedly connected in the first clasping male header (21), a hair sticking roller (23) is rotatably connected in the inner frame (22), brush plates (24) are rotatably connected to both of an upper portion and a lower portion of the hair sticking roller (23) in the inner frame (22), a torsional spring (25) is disposed between a main shaft of the brush plate (24) and the inner frame (22), a first face cover (26) is fixedly connected to an end face of the first clasping male header (21), and edges of the hair sticking roller (23) and the brush plate (24) both protrude from the first face cover (26).

9. The pet hair care kit according to claim 8, wherein the hair sticking roller (23) comprises a roller shaft (231) that is rotatably connected in the inner frame (22), rolling wheels (232) are connected to two ends of the roller shaft (231), grooming stickers (233) and silicone strips (234) are respectively connected to a surface of the roller shaft (231), and the grooming stickers (233) and the silicone strips (234) are alternately distributed on the surface of the roller shaft (231).

10. The pet hair care kit according to claim 2, wherein the second care accessory (3) comprises a second clasping male header (31) and a second face cover (36) movably connected to the second clasping male header (31), a lamp plate (32), a light transmissive plate (33), and a comb head base (34) are respectively and fixedly disposed in the second clasping male header (31) in sequence, a post hole (311) is reserved on a back face of the second clasping male header (31), a second through hole (312) is internally reserved on the second clasping male header (31), a second conductive post (321) is integrally connected to a back face of the lamp plate (32), a plurality of lamp covers (331) are integrally connected to a front face of the light transmissive plate (33), a plurality of comb teeth (35) are fixedly connected in the comb head base (34), a plurality of comb tooth moving holes (362) are reserved on a front face of the second face cover (36), the comb teeth (35) can move in the comb tooth moving holes (362), a push rod (363) is fixedly connected to a back face of the second face cover (36), the push rod (363) is inserted into the second through hole (312), and middle portions of the second clasping male header (31), the lamp plate (32), the light transmissive plate (33), the comb head base (34), and the second face cover (36) are all provided with fourth air guiding openings (361) communicating with each other.
